(19) United States
(12) Patent Application Publication
(10) Pub. No.: US 2022/0091778 A1
(43) Pub. Date: Mar. 24, 2022

(54) SEMICONDUCTOR STORAGE DEVICE AND WRITING METHOD OF OPERATION CONTROL PROGRAM OF SEMICONDUCTOR STORAGE DEVICE

(71) Applicant: Kioxia Corporation, Tokyo (JP)

(72) Inventors: Maho NAGAO, Edogawa, (JP); Yosuke HARADA, Kawasaki (JP)

(21) Appl. No.: 17/190,896

(22) Filed: Mar. 3, 2021

(30) Foreign Application Priority Data
Sep. 18, 2020 (JP) 2020-157813

(51) Int. Cl. G06F 3/06

(52) U.S. Cl. CPC G06F 3/0655; G06F 3/0679; G06F 3/0604

(57) ABSTRACT

A semiconductor storage device includes a non-volatile memory that stores an operation control program, and a memory controller configured to control the non-volatile memory. The memory controller includes an address storage that stores at least one address in which the operation control program is stored. The memory controller is configured to read the operation control program from the non-volatile memory, and execute the operation control program based on the address in response to determining that the semiconductor storage device is started.

### CROSS-REFERENCE TO RELATED APPLICATION(S)

This application is based upon and claims the benefit of priority from Japanese Patent Application No. 2020-157813, filed on Sep. 18, 2020, the entire contents of which are incorporated herein by reference.

### FIELD

Embodiments described herein relate generally to a semiconductor storage device and a writing method of an operation control program of the semiconductor storage device.

### BACKGROUND

In a semiconductor storage device having a non-volatile memory, an operation control program is stored in a specific storage area of the non-volatile memory. The operation control program is sometimes referred to as a firmware image. The firmware image is read out when the semiconductor storage device is started. When the specific storage area in which the firmware image is stored includes a faulty memory cell, the firmware image cannot be stored. In such a case, the firmware image may be stored in an alternative storage area through address management by a memory management unit (MMU).

### DESCRIPTION OF THE DRAWINGS

FIG. 1 is a block diagram illustrating a hardware structure of an information processing system according to an embodiment of the present disclosure.

FIG. 2 is a flowchart illustrating an example of a process at the time of start of a semiconductor storage device according to the embodiment.

FIG. 3 is a flowchart illustrating an example of a first process according to the embodiment.

FIG. 4 is a flowchart illustrating an example of a search operation for a writable block according to the embodiment.

FIG. 5 is a flowchart illustrating an example of a detailed process of a write operation of a firmware image according to the embodiment.

FIG. 6 is a flowchart illustrating an example of a record operation on a one time programmable ROM according to the embodiment.

FIG. 7 is a flowchart illustrating an example of a second process according to the embodiment.

### DETAILED DESCRIPTION

Embodiments provide a semiconductor storage device and a writing method of an operation control program of the semiconductor storage device, in which a firmware image may be read out without conducting an address management.

In general, according to one embodiment, a semiconductor storage device includes: a non-volatile memory that stores an operation control program, and a memory controller configured to control the non-volatile memory. The memory controller includes an address storage that stores at least one address in which the operation control program is stored. The memory controller is configured to read the operation control program from the non-volatile memory, and execute the operation control program based on the address in response to determining that the semiconductor storage device is started.

Hereinafter, an embodiment will be described with reference to drawings.

(Configuration)

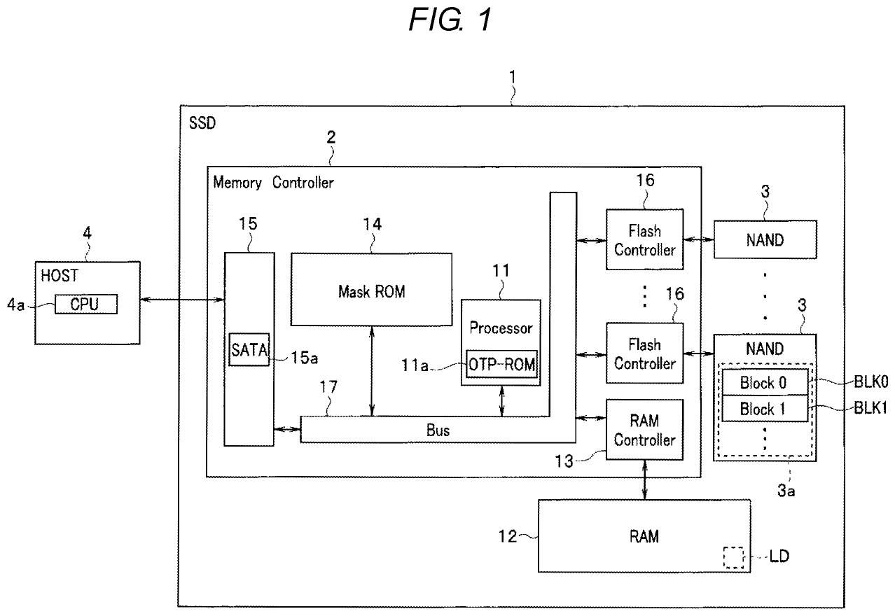

FIG. 1 is a block diagram illustrating a hardware structure of an information processing system according to an embodiment of the present disclosure.

The information processing system according to the embodiment of the present disclosure includes a host 4 and a semiconductor storage device 1.

The host 4 is, for example, a device owned by a user, and is a personal computer (hereinafter, referred to as a PC), a smartphone, or the like. The host 4 includes a central processing unit (CPU) 4a as a processor, a ROM (not illustrated), a RAM (not illustrated), etc.

The semiconductor storage device 1 is, for example, a solid state drive (SSD). The semiconductor storage device 1 may be a memory card or the like. The semiconductor storage device 1 writes user data or reads user data in response to a data write request or a data read request from the host 4. That is, the semiconductor storage device 1 is capable of writing and reading data. The semiconductor storage device 1 may be connected to the host 4.

The semiconductor storage device 1 includes a memory controller 2 and a plurality of non-volatile memories 3. The memory controller 2 is a system-on-a-chip (SoC). The non-volatile memory 3 is, for example, a NAND-type flash memory. The non-volatile memory 3 stores an FW image. The FW image is a file including an operation control program and various parameter data.

Next, the internal configuration of the memory controller 2 will be described. The memory controller 2 includes a processor 11, a RAM 12, a RAM controller 13, a mask ROM 14, a communication interface (hereinafter, communication I/F) 15, and a plurality of flash controllers 16. The processor 11, the RAM controller 13, the mask ROM 14, the communication I/F 15, and the plurality of flash controllers 16 are connected to each other via a bus 17 in a communication available manner.

The processor 11 is a central processing unit (hereinafter, CPU). The processor 11 executes an operation control program.

The RAM 12 is a volatile memory such as a DRAM, or a SRAM.

The RAM controller 13 controls writing of data to the RAM 12 and reading of data from the RAM 12.

The mask ROM 14 is a read-only integrated circuit. The mask ROM 14 stores an initial program loader (hereinafter, IPL). The IPL is a program executed by the processor 11 when the semiconductor storage device 1 is started (e.g., turned on).

The communication I/F 15 is a circuit that communicates with the outside of the semiconductor storage device 1.

The flash controller 16 is a circuit that controls writing of data and reading of data to/from the non-volatile memory 3.

Next, the internal configuration of the processor 11 will be described. The processor 11 includes a one time programmable read only memory (hereinafter, OTP-ROM) 11a. The OTP-ROM 11a is an eFuse non-volatile memory. The number of times data can be written to the OTP-ROM 11a is only one. The data written on the OTP-ROM 11a is more reliable than the data written on the non-volatile memory 3. The OTP-ROM 11a constitutes a non-volatile address storage.

Next, the internal configuration of the communication I/F 15 will be described. The communication I/F 15 includes a serial advanced technology attachment interface (SATA interface, hereinafter, SATA I/F) 15a. The SATA I/F 15a has a standard terminal, and can perform universal asynchronous receiver/transmitter communication (UART communication) by using the standard terminal. The UART communication is performed in order to write an FW image on the semiconductor storage device 1. During the UART communication, the SATA I/F 15a receives various requests or data from the host 4, or outputs read user data to the host 4.

Next, the internal configuration of the non-volatile memory 3 as a NAND type flash memory will be described. The non-volatile memory 3 as the NAND type flash memory includes a plurality of blocks BLK. The block BLK is a data erasing unit. The block BLK includes a plurality of memory cells MT. The memory cell MT is capable of storing data. The memory cell MT may be a triple level cell (TLC) capable of storing 3-bit data, or may be a quad level cell (QLC) capable of storing 4-bit data. When the memory cell MT is a multi-valued cell such as a TLC or a QLC, an FW image is stored in a pseudo Single Level Cell area (pSLC area). The pSLC area is a storage area in which 1-bit data is stored in a memory cell MT capable of storing data of 2 or more bits.

Here, the function of the IPL will be described. The IPL has two functions, a first function and a second function. The first function is a function that is executed before the semiconductor storage device is used by the user. For the first function, the IPL loads a program received by the UART communication, into the RAM 12, and executes the program. The second function is a function that is executed when the user connects the semiconductor storage device 1 to, for example, his PC and uses the semiconductor storage device 1. For the second function, the IPL reads the FW image from the non-volatile memory 3, loads the read FW image into the RAM 12, and executes the operation control program from the RAM 12. A determination on whether to execute the first function or the second function is made based on the connected state of the communication I/F 15 of the semiconductor storage device 1. The connected state is, for example, a short-circuited state of a plurality of contacts. That is, the selection of the two functions is determined by the state of the external terminal of the semiconductor storage device 1.

(Action)

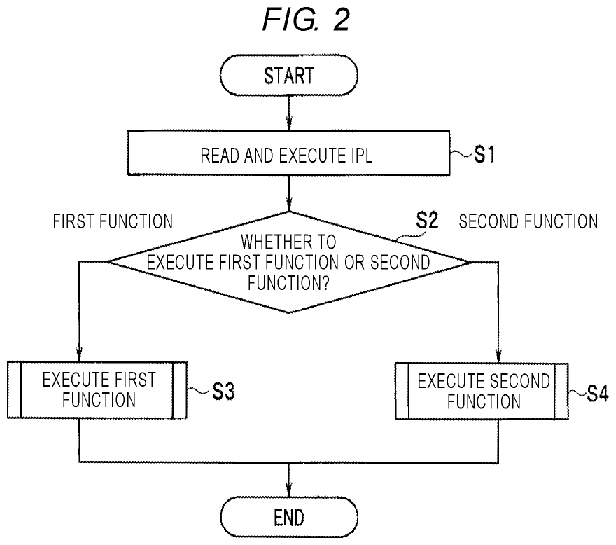

Next, the operation of the semiconductor storage device 1 will be described. FIG. 2 is a flowchart illustrating an example of a process at the time of start of the semiconductor storage device 1.

When the semiconductor storage device 1 is started (START), the processor 11 reads the IPL stored in the mask ROM 14 and executes the IPL (S1).

The processor 11 that has executed the IPL determines whether to execute the first function or the second function, based on the connected state of the communication I/F 15 of the semiconductor storage device 1 (S2).

When it is determined to execute the first function (S2: first function), the processor 11 executes the first function (S3). After executing the first function, the processor 11 ends a series of processes in FIG. 2 (END).

When it is determined to execute the second function (S2: second function), the processor 11 executes the second function (S4). After executing the second function, the processor 11 ends a series of processes in FIG. 2 (END).

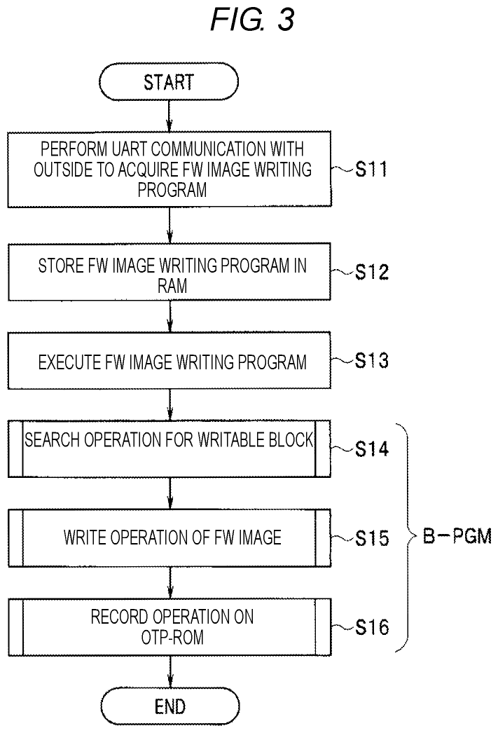

FIG. 3 is a flowchart illustrating an example of a first process. The first process relates to the first function of the IPL, and a process of an FW image writing program B-PGM. The FW image writing program B-PGM is a program that writes an FW image on a plurality of blocks.

When it is determined to execute the first function (START), the processor 11 performs UART communication with the outside through the communication I/F 15 to acquire the FW image writing program B-PGM (S11).

The processor 11 stores the acquired FW image writing program B-PGM, in the RAM 12 via the RAM controller 13 (S12).

The processor 11 executes the FW image writing program B-PGM stored in the RAM 12 (S13).

The processor 11 that has executed the FW image writing program B-PGM executes a search operation for a writable block (S14).

After S14, the processor 11 executes a write operation of the FW image (S15).

After S15, the processor 11 executes a record operation on the OTP-ROM (S16). After S16, the processor 11 ends a series of processes in FIG. 3 (END).

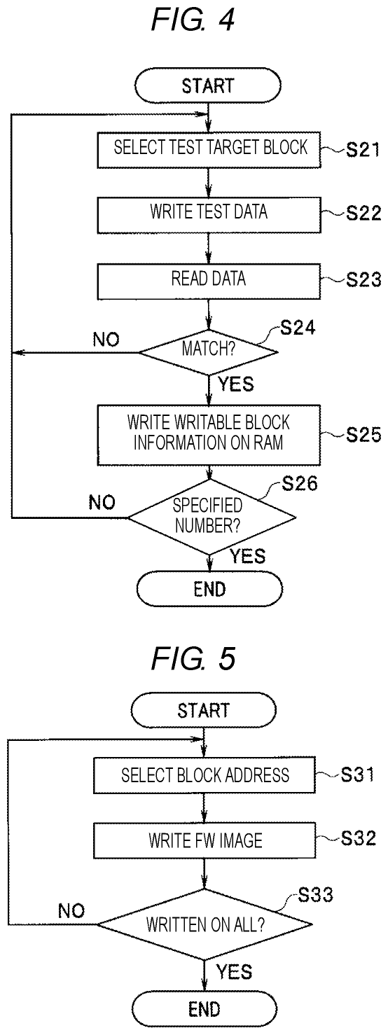

The search operation for the writable block will be described in detail by using FIG. 4. FIG. 4 is a flowchart illustrating an example of the search operation for the writable block (e.g., S14).

When the search operation for the writable block is executed (START), the processor 11 selects one predetermined block of one predetermined non-volatile memory 3 (S21). For example, initially, a block with the smallest block number in one non-volatile memory 3 is selected. At the time of the second block selection, a block with the second smallest block number is selected. The block numbers may be in a descending order, or in a predetermined order for predetermined block numbers.

The processor 11 writes test data on the block selected in S21 (S22).

The processor 11 reads data from the block selected in S21 (S23).

After S23, the processor 11 determines whether the read data matches the written test data (S24).

When it is determined that the read data matches the written test data (S24: YES), the processor 11 writes an address (physical block address PBA) of the block selected in S21, as writable block information, on a predetermined storage area of the RAM 12 (S25).

When it is determined that the read data does not match the written test data (S24: NO), the processor 11 proceeds to processing in S21.

After S25, the processor 11 determines whether the number of addresses written in S25 becomes a specified number or more (S26). The specified number is the number of redundant blocks. For example, when the specified number is 4, the processing from S11 to S15 is repeated until four addresses are written on the RAM 12. The specified number may be set for one of the plurality of non-volatile memories 3, or may be set for two or more non-volatile memories 3.

When it is determined that the number of addresses written in S25 does not become the specified number or more (S26: NO), the process proceeds to S21.

When it is determined that the number of addresses written in S25 becomes the specified number or more (S26: YES), the processor 11 ends the process in FIG. 4 (END). As a result, in list data LD of the RAM 12, a specified number of address information pieces (that is, physical block addresses PBA) are stored in a list format.

In the search operation for the writable block (S14), the test data is written and whether the test data can be correctly read is determined so that it is checked if the test data is correctly written on the non-volatile memory 3, that is, if the operation control program (FW image) can be correctly written. In the search operation for the writable block (S14), whether the operation control program (FW image) can be correctly written is checked for the plurality of blocks.

FIG. 5 is a flowchart illustrating an example of a detailed process of the write operation of the firmware image (e.g., S15). After the processing in S14 (START), the processor 11 selects one address from the list data LD in the RAM 12 (S31).

The processor 11 erases data of the block specified by the selected address, and then writes the FW image on the block specified by the selected address (S32).

After S32, the processor 11 determines whether the FW image is written on all blocks specified by all addresses in the list data LD (S33). For example, when the specified number is 4, the list data LD includes four addresses. In such a case, since the FW image is written on all four blocks related to the four addresses, the processor 11 determines whether the FW image is written on the four blocks.

When it is determined that the FW image is not written on all blocks specified by all addresses in the list data LD (S33: NO), the process proceeds to S31.

When it is determined that the FW image is written on all blocks specified by all addresses in the list data LD (S33: YES), the processor 11 ends a series of processes in FIG. 5 (END).

In the write operation of the firmware image (S15), the operation control program (FW image) is written on the blocks for which it is possible to confirm that the operation control program (FW image) can be correctly written.

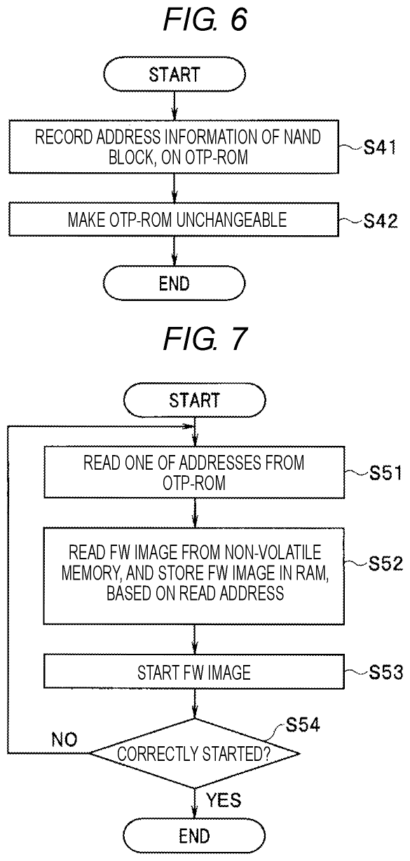

FIG. 6 is a flowchart illustrating an example of the record operation on the one time programmable ROM (e.g., S16).

After the processing in S15 (START), the processor 11 records the addresses of the NAND blocks included in the list data LD in the RAM 12, in the OTP-ROM 11a (S41). As described above, the OTP-ROM 11a is an eFuse-type ROM in which writing is possible only once. For example, when the above described specified number is 4, the processor 11 writes four addresses on the OTP-ROM 11a. That is, in S41, the addresses related to the blocks, for which it was possible to confirm that the operation control program (FW image) can be correctly written, are written on the OTP-ROM 11a. In S41, a plurality of addresses is written on the OTP-ROM 11a.

After S41, the processor 11 performs processing of making the OTP-ROM 11a unchangeable (S42). Through the processing in S42, the specified number of addresses recorded in the OTP-ROM 11a are not changed. After S42, the processor 11 ends a series of processes in FIG. 6 (END).

According to the embodiment, the FW image (operation control program) is stored in the plurality of blocks in one non-volatile memory 3, and the OTP-ROM 11a stores addresses of the plurality of blocks. Therefore, as described later, the processor 11 may select one address from the plurality of addresses recorded in the OTP-ROM 11a, read the operation control program from a block corresponding to the selected address, and execute the operation control program. According to the embodiment, the FW image is stored in the plurality of blocks.

FIG. 7 is a flowchart illustrating an example of a second process. The second process relates to the second function of the IPL.

When it is determined to execute the second function (START), the processor 11 reads one of a plurality of addresses, from the OTP-ROM 11a (S51). For example, initially, an address with the smallest number is selected from the plurality of addresses. For example, the second time, an address with the second smallest number is selected from the plurality of addresses.

The processor 11 reads the FW image from the non-volatile memory 3 based on the address read in S51, and stores the FW image in the RAM 12 (S52).

The processor 11 starts the FW image stored in the RAM (S53), and determines whether the FW image is correctly started (S54). Whether the FW image is correctly started may be confirmed by checking, for example, whether a predetermined operation is executed.

When it is determined that the FW image is correctly started (S54: YES), the processor 11 ends a series of processes in FIG. 7 (END).

When it is determined that the FW image is not correctly started (S54: NO), the processor 11 proceeds to the processing in S51.

According to the embodiment, when the operation control program read from a block corresponding to the selected address is not correctly executable, the processor 11 selects another address from the plurality of addresses, reads the operation control program from a block corresponding to another selected address, and executes the operation control program. According to the embodiment, since the FW image is recorded in the plurality of blocks with the plurality of addresses, the FW image may be started with a high probability. According to the embodiment, it is possible to provide a semiconductor storage device and a writing method of an operation control program of the semiconductor storage device, in which an FW image can be read without address management. According to the embodiment, the semiconductor storage device 1 searches for a block on which data can be correctly written. The FW image is stored in a plurality of blocks on which data can be correctly written. Address information of the blocks on which the FW image is written is recorded in the OTP-ROM 11a. The semiconductor storage device 1 reads the FW image based on the addresses stored in the OTP-ROM 11a.

In the above-described embodiment, a plurality of blocks on which the FW image can be correctly written is searched for, and a plurality of addresses of the plurality of blocks is written on the OTP-ROM 11a. Meanwhile, one block on which the FW image can be correctly written may be searched for, and an address of the one block may be written on the OTP-ROM 11a.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A semiconductor storage device comprising:
a non-volatile memory that stores an operation control program; and
a memory controller configured to control the non-volatile memory,
wherein the memory controller includes an address storage that stores at least one address in which the operation control program is stored, and
the memory controller is configured to read the operation control program from the non-volatile memory, and execute the operation control program based on the address in response to determining that the semiconductor storage device is started.

2. The semiconductor storage device according to claim 1, wherein the memory controller is configured to select a first one from a plurality of addresses, and read and execute the operation control program based on the first address.

3. The semiconductor storage device according to claim 2, wherein in response to determining that the operation control program is not correctly executable, the memory controller is configured to select a second one from the plurality of addresses, and read and execute the operation control program based on the second address.

4. The semiconductor storage device according to claim 1, wherein the address storage includes a one time programmable read only memory (ROM).

5. The semiconductor storage device according to claim 4, wherein the one time programmable ROM includes an eFuse.

6. A method of writing an operation control program on a semiconductor storage device, the method comprising:
determining whether the operation control program can be correctly writable on a non-volatile memory,
writing the operation control program, responsive to determining that the operation control program is correctly writable, and
writing at least one address in which the operation control program is stored in an address storage.

7. The method according to claim 6, wherein the step of determining whether the operation control program can be correctly writable includes:
searching a plurality of blocks in the non-volatile memory, and
writing a plurality of addresses in the address storage.

8. The method according to claim 6, wherein the address storage includes a one time programmable ROM.

9. The method according to claim 8, wherein the one time programmable ROM includes an eFuse.

10. The method according to claim 7, further comprising:
selecting one of the blocks, writing test data to the selected block, and reading test data from the selected block until the written data and read data match so as to write one of the plurality of addresses that corresponds to the selected block in the address storage.

11. The method according to claim 10, wherein the address includes a physical block address.

12. The method according to claim 10, further comprising iteratively writing one of the plurality of addresses until a number of the addresses written meets a threshold.

13. A semiconductor storage device comprising:
a non-volatile memory; and
a memory controller, operatively coupled to the non-volatile memory, that is configured to:
determine whether an operation control program can be correctly writable on the non-volatile memory,
write the operation control program, responsive to determining that the operation control program is correctly writable, and
write at least one address in which the operation control program is stored in an address storage.

14. The semiconductor storage device according to claim 13, wherein the memory controller includes the address storage.

15. The semiconductor storage device according to claim 14, wherein the address storage includes a one time programmable ROM.

16. The semiconductor storage device according to claim 13, wherein the memory controller is further configured to:
select one of a plurality of blocks;
write test data to the selected block; and
read test data from the selected block until the written data and read data match as so to write one of a plurality of addresses that corresponds to the selected block in the address storage.

17. The semiconductor storage device according to claim 16, wherein the memory controller is further configured to iteratively write one of the plurality of addresses until a number of the addresses written meets a threshold.
